(19) United States
(12) Patent Application Publication
(10) Pub. No.: US 2025/0227331 A1
(43) Pub. Date: Jul. 10, 2025

(54) ENABLING OF APPLICATION STYLE INTERACTIVE FEATURES, PERSONALISATION AND USER TRANSACTIONS ON BROADCAST LINEAR TV CHANNELS

(71) Applicant: Magic Media Works Limited t/a ROXi, London (GB)

(72) Inventors: Rob LEWIS, London (GB); William MORGAN, London (GB)

(21) Appl. No.: 19/013,816

(22) Filed: Jan. 8, 2025

Related U.S. Application Data
(60) Provisional application No. 63/618,624, filed on Jan. 8, 2024.

(51) Int. Cl. H04N 21/462; H04N 21/435; H04N 21/81

(52) U.S. Cl. CPC H04N 21/462; H04N 21/435; H04N 21/8173

(57) ABSTRACT

A television device configured to receive both broadcast channel data and meta data including the identity of what content or instructions should be played or initiated by the television device when the consumer selects a certain channel among a plurality of broadcast channels. The meta data is configured to command a full screen takeover, the playing of a video from a video streaming server when the certain channel is selected and a command instructing the television device to commence the download of an auto-downloadable application program. The auto-downloadable application program may then be configured to be used for delivering at least one of interactive features, controls, transaction capabilities and personalisation functions with controls and iconography appearing following the real-time playback of the video streamed from the video streaming server.

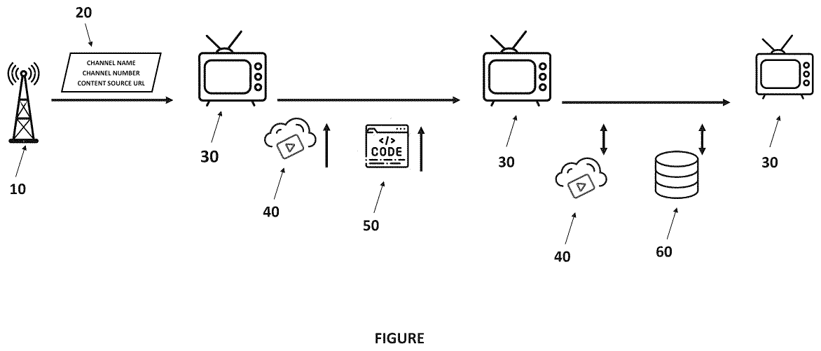

### CROSS-REFERENCE TO RELATED APPLICATIONS

This application claims priority to U.S. provisional application No. 63/618,624 filed Jan. 8, 2024, which is incorporated herein in its entirety.

### TECHNICAL FIELD

The present disclosure relates generally to enabling consumers who are watching linear broadcast tv channels to receive a personalised experience, control their tv viewing experience and command transactions on a standard linear broadcast tv and without the need to download or launch a separate TV application in order to access such features.

### BACKGROUND

For many years consumers have enjoyed the instant accessibility of linear broadcast TV. Consumers simply have to turn on the TV to enjoy a variety of linear broadcast TV channels that are almost instantly available and easily accessible either through an electronic programming guide or alternatively by simply pressing “up channel” or “down channels” on the remote control. However, there are limitations to the consumer experience in that TV programming is the same for every user at the same time, and the consumers will usually find the programme on a channel has already started. The only control a consumer generally enjoys is the ability to switch channel. For a consumer to enjoy interactive features, such as play, pause, skip, or the ability to transact (e.g. upgrade, buy or bet), or the ability to receive personalised content, it has been necessary to deliver content to the consumer through a separate TV application which needs to be developed for each and every TV model and platform and then downloaded and/or installed on the TV by the consumer or manufacturer, and then launched and navigated by the consumer, and only then can it be used to commence the streaming of interactive content. This invention uses the architecture of digital linear broadcast TV to deliver the interactive features of a downloadable app on linear broadcast TV without the need for the development, downloading and/or installation of a permanent app and still with the same near instant accessibility enjoyed by consumers watching or viewing broadcast or linear tv.

### Problems with the Prior Art

A broadcast TV channel may wish to allow consumers viewing a broadcast TV channel to receive personalised content based on their previous viewing behaviour or other characteristics, to be able to skip, pause, or change genre or topic, or to transact (e.g. buy, upgrade, purchase, bet) without the need for them to leave the broadcast TV experience and download or install a dedicated application. This is particularly the case given some devices cannot support downloadable apps, may not have app available on them, that downloading applications can be troublesome for some consumers, that downloaded apps can be difficult to access on many TVs, that downloadable apps need to be redownloaded whenever there is an update, and that the downloading and launch of smart tv apps is a relatively slow, complicated, inefficient process.

There is thus a need for a method of enabling broadcast TV channels to provide personalised and interactive and transactional features to consumers without the need to download, install or launch a separate TV application and without compromising the near instant availability and ease of access associated with linear broadcast TV.

### SUMMARY

The above described problem is addressed by the claimed system and method for enabling app style interactive features, personalisation and user transactions on broadcast linear TV channels.

The claimed system may comprise: (a) a channel descriptor, which is broadcast over the airways repeatedly to receiving TVs in the broadcast area by the digital broadcast system and which provides the name, channel number, and content source destination meta data including the identity of what content or behaviour should be played or initiated by the TV when the consumer selects each channel noting the content source destination meta data may consist of details of the spectrum to be utilised for receiving the transmission and/or an internet location/URL or function to be called by the TV when the channel is launched, (b) a URL which describes the immediate actions for the TV to initiate when the channel is called and which may optionally include an identifier for the device or user requesting connection inserted by the requesting device, (c) a video streaming server, with a catalogue of live or pre-recorded music video files that can be played by the TV (d) an auto-downloadable application to be delivered to the TV automatically without human intervention to enable interactive features but which can optionally be temporary in so far as it is removed from the TV when the consumer switches channel or turns off the TV and (e) a server side platform to manage the interactive features, personalisation and transactions associated with an individual user and make third party calls to third party systems as appropriate.

In aspects and embodiments, the technology disclosed relates to a television device configured to receive both broadcast channel data and meta data including the identity of what content or instructions should be played or initiated by the television device when the consumer selects a certain channel among a plurality of broadcast channels, wherein the meta data is configured to command a full screen takeover, the playing of a video from a video streaming server when the certain channel is selected and a command instructing/triggering the television device to commence the download of an auto-downloadable application program. The auto-downloadable application program may then be configured to be used for delivering at least one of interactive features, controls, transaction capabilities and personalisation functions with controls and iconography appearing following the real-time playback of the video streamed from the video streaming server.

In aspects and embodiments, the technology disclosed relates to a television device configured to receive both broadcast channel data and meta data comprising a first command instructing the television device to initiate the streaming of a video from a video streaming server a second (parallel) command instructing the TV to commence the download of an auto-downloadable application program configured to be used for delivering (for example at least a couple of seconds after the start of playing the streamed video on the television device) at least one of interactive features, controls, transaction capabilities and personalisation functions with controls and iconography appearing following the real-time playback of the video streamed from the video streaming server.

In aspects and embodiments, the technology disclosed relates to a television device configured to receive both broadcast channel data and meta data including the identity of what content or instructions should be played or initiated by the TV when the consumer selects a channel, wherein the meta data comprises a URL which commands a full screen takeover, playing of a video streamed from a video streaming server and the the download of an auto-downloadable application program configured to be used for delivering interactive features and/or functions. The meta data may then include the identity of what content or instructions should be played or initiated by the TV when the consumer selects a certain channel among a plurality of broadcast channels.

In embodiments and when the TV launches the channel (changes channel), the URL may initially command a full screen takeover and playing of a video from the video streaming server, such that the consumer experiences near instant video playback as expected in a broadcast or linear TV context. Once the video playback has commenced a parallel command that instructs the TV to commence the download of the auto-downloadable application used to deliver at least one of interactive features, controls, transaction capabilities and personalisation functions with controls and iconography appearing some seconds later following video play in real-time.

The claimed method may comprise: the continual broadcast of the channel descriptor that includes the channel's name, channel number content source destination with the latter being a URL which initially commands a full screen takeover and playing of a video from the video streaming server, such that the consumer experiences near instant video playback in as expected in a broadcast or linear TV context. Once the video playback has commenced a parallel command instructs the TV to commence the download of the auto-downloadable transient application which will be used to deliver interactive features, controls, transaction capabilities and personalisation functions with controls and iconography appearing some seconds later following video play. This application may optionally be transient and temporary and lost if the consumer changes channel but whilst they remain on the same channel communicates over IP to the server side platform and streaming video server to access additional video content, manage interactive features, accept transactions (be this purchases, premium upgrades, gambling, betting or other functions) and make third party calls to third party systems as appropriate.

Optionally the application may use Local Storage on the TV device to maintain information related to personalization of the experience across sessions. This facility may not be available on all TV's and the claimed system operates without this facility available.

When the viewer leaves or changes the channel the memory allocated to the application may be freed up. Control of TV and all resources is handed back to the TV until such time as the consumer revisits the channel.

In totality, this enables the linear broadcast TV channel to deliver all the capabilities, personalisation, interactive and transactional capabilities of a downloaded dedicated smart tv application on a device which only has access to broadcast TV channel, instantly in a manner akin to traditional broadcast tv and without the need to download, launch, register, store or otherwise use a downloaded or pre-installed tv application and without the need for a large amount of storage to be dedicated to multiple interactive applications or indeed for delays to be experienced whilst applications are downloaded or launched.

The various modules of the system may be physically separate modules between which information is sent, but may also be virtual modules implemented on the same server, or simply software modules.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments.

### BRIEF DESCRIPTION OF THE FIGURES

Embodiments of the present invention will be further explained below with reference to the accompanying FIGURE, in which:

FIGURE shows a schematic illustrating the flow of information from the broadcast to the device.

### DETAILED DESCRIPTION OF PARTICULAR EMBODIMENTS

Embodiments of the present invention will be described with reference to the FIGURE. The FIGURE gives an overview of an embodiment of the invention. Specifically, the FIGURE illustrates the flow of information from the broadcast to the device and subsequent interactions that enables broadcast TV channels to provide personalised and interactive and transactional features to consumers without the need to download, install or launch a separate TV application and without compromising the near instant availability and ease of access associated with linear broadcast TV.

In embodiments, a TV transmitter 10 broadcasts a channel descriptor 20, which is sent over the airways repeatedly to receiving TVs 30 in the broadcast area by the digital broadcast system. The channel descriptor 20 provides the name, channel number, and content source URL metadata including the identity of what content should be played by the TV when the consumer selects that channel which may consist of details of the spectrum to be utilised for receiving the transmission and/or an internet location/URL or function to be called by the TV. The content source URL metadata provided by the channel descriptor describes a definition of immediate actions for the TV to initiate on the channel being called.

When a consumer accesses a channel on a receiving TV, the receiving TV launches the channel and the URL metadata initially commands a full screen takeover and playing of a video from the video streaming server 40, such that the consumer experiences near instant video playback in as expected in a broadcast or linear TV context. The URL metadata 40 may include an identifier inserted by the device and identifying that device to enable continuity and enrichment of the experience.

Once the video playback has commenced a parallel command instructs the TV to commence the download of the auto-downloadable transient application 50 which will be used to deliver interactive features, controls, transaction capabilities and personalisation functions with controls and iconography appearing some seconds later following video play.

The application may optionally store information to local storage on the device to enable continuity and enrichment of the experience.

This application may optionally be transient and temporary and lost if the consumer changes channel, but whilst they remain on the same channel communicates over IP to the server side platform 60 and streaming video server 40 to access additional video content, manage interactive features, accept transactions (be this purchases, premium upgrades, gambling, betting or other functions) and make third party calls to third party systems as appropriate.

The transient application 50 manages interactive features and transactions and content delivery until consumer changes channel. Interactive features appear on screen layered on top of the initial video. Consumers interacting with such features will lead to commands and data being issued or delivered or requested from the server side platform 60 and/or the video streaming server 40.

The transient application 50 optionally may be deleted from the platform when consumer moves to an alternative channel with memory freed up and all resources restored. Alternatively, the application 50 may remain in local storage to speed up interaction at a later time.

1. A television device configured to receive both broadcast channel data and meta data including identity of what content or instructions should be played or initiated by the television device when a consumer selects a certain channel among a plurality of broadcast channels, wherein the meta data is configured to command a full screen takeover, a playing of a video from a video streaming server when the certain channel is selected and a command instructing the television device to commence a download of an auto-downloadable application program, wherein the auto-downloadable application program is configured to be used for delivering at least one of interactive features, controls, transaction capabilities and personalization functions with controls and iconography appearing following real-time playback of the video streamed from the video streaming server.

2. A television device configured to receive both broadcast channel data and meta data comprising a first command instructing the television device to initiate streaming of a video from a video streaming server and a second command instructing the television device to commence download of an auto-downloadable application program configured to be used for delivering at least one of interactive features, controls, transaction capabilities and personalization functions with controls and iconography appearing following real-time playback of the video streamed from the video streaming server.

3. A method comprising:
continually broadcasting a channel descriptor that includes the channel's name, channel number content source destination with the latter being a URL which initially commands a full screen takeover and playing of a video from a video streaming server, such that the consumer experiences near instant video playback as expected in a broadcast or linear TV context; and
once the video playback has commenced, a parallel command instructs the TV to commence download of an auto-downloadable transient application which will be used to deliver interactive features, controls, transaction capabilities and personalization functions with controls and iconography appearing following instant playback of the video streamed from the video streaming server.
